(19) United States
(12) Patent Application Publication
(10) Pub. No.: US 2007/0283825 A1
(43) Pub. Date: Dec. 13, 2007

(54) ROLLER DRIVE END AND METHOD FOR MOUNTING THE SAME

(76) Inventors: Herbert Bosch, Gerstetten (DE); Werner Gobel, Lauingen (DE); Martin Jauch, Langenau (DE)

Correspondence Address: TAYLOR & AUST, P.C., P.O. Box 560, 142. S Main Street, Avilla, IN, 46710, US

(21) Appl. No.: 11/696,329

(22) Filed: Apr. 4, 2007

(30) Foreign Application Priority Data
Apr. 27, 2006 (DE) 10 2006 020 242.2

(51) Int. Cl. B41F 5/04

(52) U.S. Cl. 101/219; 29/895.21

(57) ABSTRACT

This invention relates to a drive end of a roller for producing and/or treating a material web, in particular a paper web or paperboard web, the drive end including a hollow-cylinder-shaped roller casing and a drive journal which is connected to the roller casing in order to drive said casing. The drive journal stands in a driven connection to a drive unit or can be switched into such a driven connection. The drive journal has an axial bore in the direction of the axis of rotation of the roller, said bore extending from an outer end face of the drive journal to an inner end face of the drive journal inside the roller casing. Provision is made on the outer end face of the drive journal for a drive flange by way of which a drive torque can be transmitted onto the drive journal. The drive flange has a tensioner or is connected to such a tensioner, which extends through the axial bore of the drive journal and is tensioned against the inner end face such that it tensions the drive flange against the outer end face or tensions it friction-locked and/or form-locked in the region of the outer end face of the drive journal.

### BACKGROUND OF THE INVENTION

1. Field of the Invention

This invention relates to an end-face end of a roller, by way of which the roller can be driven such that it performs a rotary movement about its longitudinal axis. The roller is in particular a roller for producing and/or treating a material web, in particular paper or paperboard. In addition, this invention relates to a method for mounting or converting such a roller drive end.

2. Description of the Related Art

Such rollers, for example the drying cylinder of a paper machine, are traditionally driven on the driven end of the drying section by way of a drive journal which is coupled by way of a featherkey to an articulated shaft or a solid steel coupling. The drive journal can be driven in this case by way of an individual drive or by way of a power take-off gear which divides the drive power of one drive unit among several rollers.

In particular when connecting an individual drive—meaning when each roller is driven by way of an own drive unit—connecting the drive regularly requires that a drive flange be connected to the drive journal, by way of which flange the drive torque or drive power is transmitted from the drive unit to the drive journal in order to rotate the roller in the required direction. The drive flange is bolted in this case with a multiplicity of bolts onto the outer end face of the drive journal in order to be able to transmit the required high torque from the drive flange to the drive journal by way of the corresponding number of bolts.

In practice it has turned out that, particularly when converting existing roller drives to individual drives arranged in particular on the so-called operator end of the paper machine, considerable refinishing work is required locally for the subsequent drilling of essential threaded bores for the axial threaded connection, and that frequently the small wall thickness of the drive journal makes it impossible or difficult to add corresponding bores with a large diameter.

What is needed in the art is a roller drive end with a drive flange connected to the drive journal, with which drive flange the previously mentioned problems are avoided and in particular a secure connection is obtained between the drive flange and the drive journal, wherein on the one hand said connection can be mounted with little effort even locally and on the other hand it enables the transmission of a high torque. Also disclosed is a method with which the roller-shaped drying cylinder of a paper machine can be retrofitted with a corresponding drive end in order to drive the drying cylinder in particular by way of an individual drive on the operator end or the driven end.

### SUMMARY OF THE INVENTION

The present invention provides a roller drive end which is particularly suitable for driving the roller by way of a drive unit on the operator end. Of course it is also possible, however, for the drive end of the roller on the driven end to be configured accordingly and for the roller to be driven by way of a corresponding drive unit on the driven end. The driven end is understood in this case to be the end of the axial end of the rollers at which the rollers were traditionally driven by drive units, said axial end being mounted by way of an axial radial bearing. The operator end is understood to be the opposite axial end of the roller, which end is accessible to the machine operator during operation of the roller and on which the roller is movably mounted by way of a radial bearing.

The roller can be driven in particular by way of an individual drive, meaning that given a multiplicity of rollers arranged side by side or one above the other each roller is driven by an own drive unit, wherein the drive unit is mounted, for example mounted overhung, in particular on the drive journal or the drive flange.

In detail the drive end of a roller for producing and/or treating a material web, in particular a paper web or paperboard web, has a drive journal connected to a hollow-cylinder-shaped roller casing, by way of which journal the roller casing can be driven to rotate. The drive journal is usually connected, for example bolted, to the roller casing such that said journal is torsionally rigid. Also possible of course is a one-piece version or a welded connection or the like.

The drive journal stands in a driven connection to a drive unit or can be switched into such a driven connection. In particular the drive journal stands in a permanent driven connection to an individual drive unit which is used solely to drive the roller in question.

The drive journal has an axial bore which extends in the direction of the axis of rotation and in particular in line therewith. The axial bore extends from an outer end face of the drive journal, which is usually arranged axially outside the roller casing, to an inner end face of the drive journal, which is arranged axially inside the roller casing. The inner end face is in particular accessible only from the interior space of the roller casing such that provision can be made, in particular in the region of the end-face end between the drive journal and the roller casing, for a manhole opening through which a fitter can get into the interior space enclosed by the roller casing. For example, the manhole opening can be provided in a cylinder cap which connects the drive journal to the roller casing, wherein the cylinder cap is constructed to be integral, meaning in one piece, with the drive journal and made of cast iron such as GG-25 for example.

In the region of or on the outer end face of the drive journal provision is made for a drive flange by way of which a drive torque or drive power from the drive unit can be transmitted directly or indirectly onto the drive journal.

According to one embodiment of the invention, a rotor of the drive unit is flange-fitted or generally connected to the drive flange. However, according to another embodiment it is also possible for the rotor to be constructed in one piece with the drive flange.

According to the invention the drive flange has a tensioner which extends through the axial bore of the drive journal from the outer end face to the inner end face. The tensioner is tensioned against the inner end face, for example by way of a provided pressure plate, such that it tensions the drive flange against the outer end face of the drive journal or tensions it, at least in the region of the outer end face of the drive journal, friction-locked and/or form-locked with the drive flange.

The drive flange with its tensioner is thus inserted like a core into the drive journal and can be welded, bolted or otherwise connected thereto. However, tensioning the drive flange with the help of the tensioner against the drive journal creates a functional face of a friction-locked connection or form-locked connection, which transmits the biggest part of the torque to be transmitted from the drive flange driven by the drive unit onto the drive journal.

The tensioner can include a single tie-rod or a multiplicity of tie rods which are arranged in particular parallel to each other. The tie-rod is understood in this case to be that region of the tensioner which is elongated in the axial direction of the roller and connected to the drive flange, in particular to that axial section of the drive flange which is arranged axially outside the outer end face of the drive journal.

According to another embodiment of the present invention, no provision is made in the region of the outer end face of the drive journal, against which the drive flange rests on the drive journal, for any bolting of the drive flange to the drive journal; instead the transmission of torque at this point is performed solely by way of a friction-locked connection.

The drive journal can be mounted in a bearing, in particular a rolling bearing. The entire roller can thus be carried by this drive journal and usually a second journal, which is provided on the opposite axial end of the roller and mounted likewise in a bearing. If the roller drive end is arranged on the operator end of the roller and this end is subject to axial displacement due to thermal expansion, then the bearing carrying the roller journal of the roller end can be constructed advantageously as a toroidal roller bearing. Such a toroidal roller bearing has barrel-shaped, convex rollers as rolling elements, which enable any alignment errors and axial offsets of the drive journal to be compensated. Such toroidal roller bearings are available under the protected name CARB from the company SKF for example.

Particularly if the drive unit, for example in the form of an electric motor, is mounted overhung on the drive journal or carried by the drive flange, then provision can be made for a torque arm on the stator of the drive unit, with which arm the stator is braced against the bearing or against a support carrying the bearing or an assigned foundation. Bracing by way of the torque arm can be effected advantageously in that the bracing forces in the plane of the axial center, in particular in relation to the rolling elements of the bearing, are dissipated.

The inventive method for mounting a corresponding roller drive end on an existing drying cylinder of a paper machine provides for the existing axial bore of the roller journal, into which traditionally a steam head or a siphon of a steam pipeline system for channeling steam into the drying cylinder is inserted, to be used to fasten the drive flange by way of the tensioner to the roller journal in order to drive said journal. For this purpose the steam head or the siphon of the steam pipeline system is removed from the journal and the tensioner is installed in place of the steam head or siphon. Hence the inventive design of the roller drive end is particularly suitable for conversions, meaning for retrofitting existing rollers with a new drive concept.

The inventive conversion method provides for a driven journal with the inventive construction to be made from a non-driven journal of a roller for producing and/or treating a material web, in particular of a drying cylinder. In this case there are various ways in which the conversion can be effected. For example, either the tensioner can be inserted in an existing axial bore of the journal of the roller in order, through tensioning of the tensioner on the inner end face of the journal, to tension the drive flange against the outer end face or to tension it friction-locked and/or form-locked in the region of the outer end face of the journal. If necessary, the axial bore can be adapted in advance for inserting the tensioner, for example it can be re-bored or generally enlarged.

If there is no axial bore in the journal yet, a suitable axial bore can be added to the journal of the previously non-driven roller end prior to inserting the tensioner in the journal. Alternatively it is possible to replace the journal without a bore or suitable bore with a new journal, in which case the new journal already has a suitable axial bore.

Finally it is also possible, in the event that the existing journal has no axial bore or no axial bore with a suitable shape, to join another journal to the existing journal. The joined journal then already has the axial bore in the required shape.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is shows the axial end of a drying cylinder with a cylinder journal from whose axial bore a steam head has been removed;

FIG. 2 shows a tensioner of a drive flange, said tensioner being passed through the axial bore of the cylinder journal from FIG. 1 in order to drive the roller by way of a drive unit by way of the drive flange and the journal (now called drive journal);

FIG. 3 shows a version of the drive flange which differs from that in FIG. 2 and enables the removal of the rolling bearing in which the drive journal is mounted;

FIG. 4 shows another alternative embodiment of the drive flange which is wedged in addition by way of a ring tension set against the drive journal and is connected by way of an adapter flange to the rotor of the drive unit;

FIG. 5 shows a version constructed in accordance with FIG. 2 but with the drive flange pinned in addition to the drive journal; and

FIG. 6 shows an embodiment with a two-part drive flange but with the drive flange pinned in addition to the drive journal.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

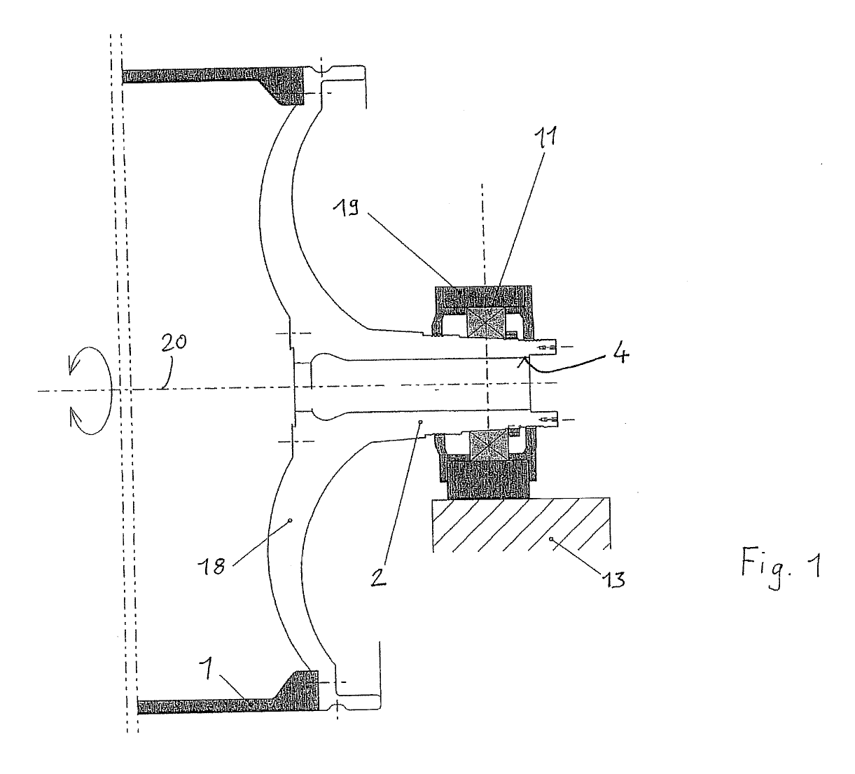

Referring now to the drawings, and more particularly to FIG. 1, there is shown a hollow-cylinder-shaped roller casing 1 of a drying cylinder, wherein, on the face end, said casing opens into a cylinder journal (here referred to as drive journal 2 because it is intended to drive the roller) via a cylinder cap 18. The drive journal 2 is mounted in a bearing 11 in the form of a rolling bearing. The bearing 11 has a multiplicity of rolling elements which are enclosed by a bearing housing 19. The bearing housing 19 is mounted in turn on a foundation or support 13.

In FIG. 1, the drive journal 2 has an axial bore 4 which extends along the axis of rotation 20 of the roller. The axial bore 4 was traditionally used to accommodate a steam head of a steam pipeline system. With this steam pipeline system (not shown) it was possible to direct steam into the drying cylinder in order to heat up the roller casing 1 therewith and thus dry a material web on the outer surface of the drying cylinder. In the representation shown, the steam head was already removed from the axial bore 4.

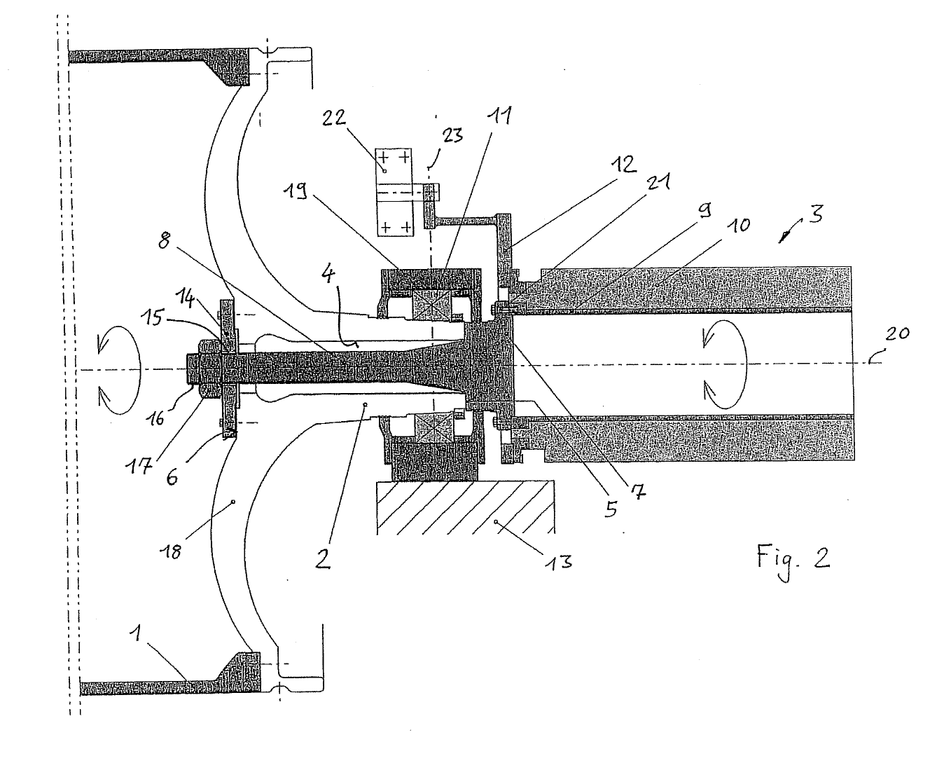

In FIG. 2 it is evident that a drive flange 7, which has an elongated tensioner 8, has been inserted in the axial bore 4. The tensioner 8 is thus enclosed by the drive journal 2 in the circumferential direction. The drive flange 7 rests flush against the outer end face 5 of the drive journal 2. The faces of the reciprocal contact between drive flange 7 and drive journal 2 can be machined in order to produce a good friction-locked connection.

Resting flush against the inner end face 6 of the drive journal 2 is a pressure plate 14 through which the tensioner 8 is passed. In this case the pressure plate 14 has a bore 15 which is arranged centrally in the pressure plate 14.

In the region of the axial end on which the pressure plate 14 is arranged, the tensioner 8 is equipped with a male thread 16. Screwed on the male thread 16 is a tensioning device 17, here in the form of a hexagonal nut. Said nut can be secured against loosening. When the tensioning device 17 is tightened, the pressure plate 14 and hence the tensioner 8 is tensioned against the inner end face 6 of the drive journal 2. This tensioning results also in the drive flange 7 in the region of the other axial end of the tensioner 8 being pressed against the outer end face 5 such that a functional face for the transmission of force or torque from the drive flange 7 to the drive journal 2 by way of a friction-locked connection is formed on the other end face 5. In addition to the friction-locked connection it is also possible to provide a form-locked connection, for example by way of suitable depressions and projections on the end face 5 of the drive journal 2 and on the opposite end face of the drive flange 7. The form-locked connection can be produced by way of Hirth teeth. Also, the form-locked connection can be produced by pinning the drive flange 7 to the drive journal 2, in which case the pins used are in particular cylindrical pins, tapered pins or shearing dowel pins.

The drive flange 7 is connected, torsionally rigid, by way of a bolted flange joint 21 to the rotor 9 of the drive unit 3 in the form of an electric motor. The rotor 9 is enclosed by a stator 10 in the circumferential direction. The entire drive unit 3 is mounted overhung on the drive flange 7.

The stator 10 is supported in a preselected fixed point 22 by way of a torque arm 12 on the support 13. In this case the supporting forces can be dissipated into the support 13 in the plane 23 of the axial center of the bearing 11.

The bearing 11 can be constructed as a CARB® bearing, a self-aligning roller bearing or a tapered-roller bearing.

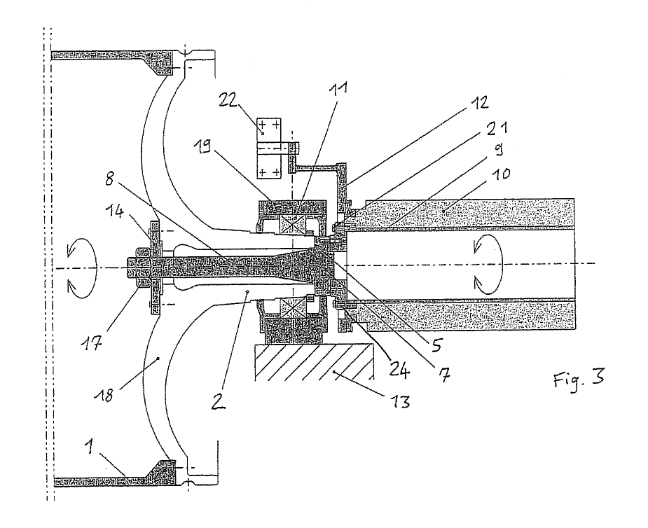

The version shown in FIG. 3 differs essentially from the version in FIG. 2 in that, at least in the region axially outside the outer end face 5 of the drive journal 2, the drive flange 7 has a maximum outer diameter which is equal to or smaller than the outer diameter of the drive journal 2 at the axial point at which the drive journal 2 is carried directly by the bearing 11. This means that the drive flange 7 also has a maximum outer diameter which is smaller than the inner diameter of the bearing 11. On the version shown, the maximum outer diameter of the drive flange 7 is also equal to or smaller than the axially outer diameter of the drive journal 2. Hence it is possible to replace the bearing 11 without having to dismantle the drive flange 7. The tensioner 8 can thus remain tensioned.

Another differentiating feature in FIG. 3 is the arrangement of an adapter flange 24 between the drive flange 7 and the rotor 9. The adapter flange 24 is bolted to the drive flange 7 as well as to the rotor 9, in particular on the end face in each case. However, the version according to FIG. 3 can be constructed just as well without the adapter flange 24 given a direct connection of the rotor 9 to the drive flange 7.

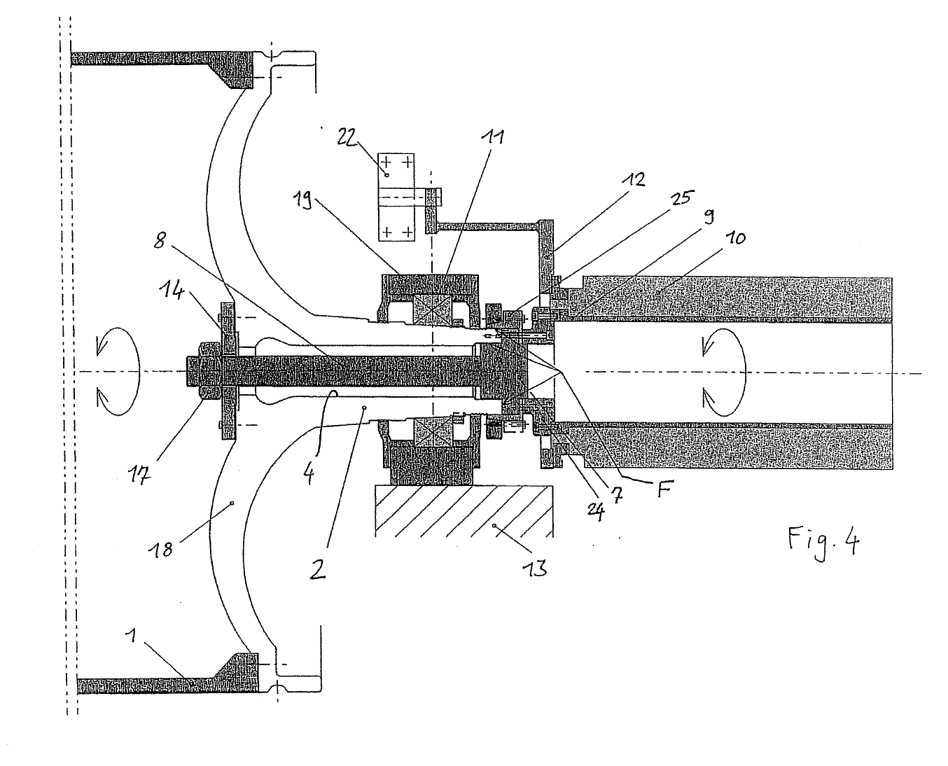

On the version shown in FIG. 2 and again on the version shown in FIG. 3 the transmission of torque from the drive flange 7 to the drive journal 2 is effected essentially by way of the outer end face 5 and a corresponding friction-locked connection or form-locked connection produced there. On the version shown in FIG. 4 this functional face for transmitting torque or for transmitting force is enlarged in that a friction-locked connection is also produced between the outer circumference of the drive flange 7 and the hole cavity of the axial bore 4 and between a ring tension set 25, which is pushed from outside onto the drive journal 2, and the drive journal 2. The primary functional face is identified in FIG. 4 with the reference symbol F.

As can be seen, the ring tension set 25, which has a wedge-shaped or conically expanded element extending in the axial direction and a ring mounted thereon, wedges the drive flange 7 or the element bolted to the drive flange 7 against the drive journal 2. By pulling together the ring and the wedge-shaped element in axial direction and accordingly pushing the ring further onto the wedge-shaped element, the wedge-shaped element or the ring tension set 25 is pressed from the outside against the outer casing surface of the drive journal 2. The ring tension set 25 is bolted to the drive flange 7.

The friction-locked connection between the hole cavity of the axial bore 4 and the outer casing surface of the drive flange 7 can be produced, for example, by these two components also extending conically relative to each other. Alternatively or in addition, the drive flange 7 can be shrink-fitted into the axial bore 4.

On the embodiment shown in FIG. 4 it is likewise possible to do without the adapter flange 24 and instead to connect the rotor 9 directly to the drive flange 7.

On all embodiments it is also possible to construct the rotor 9 in one piece with the drive flange 7.

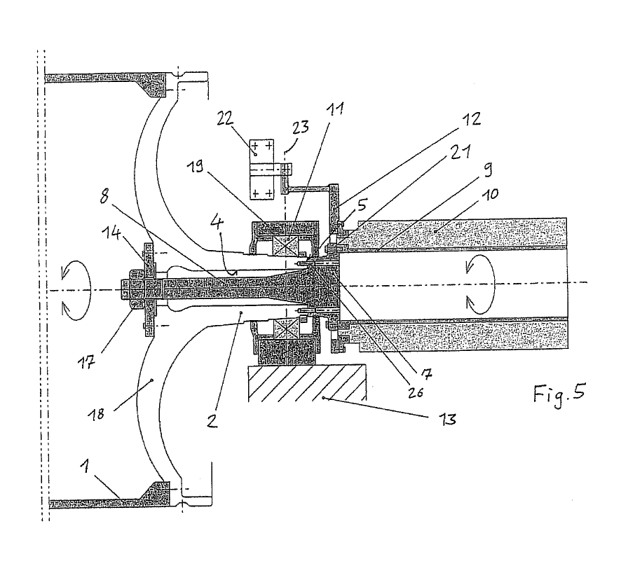

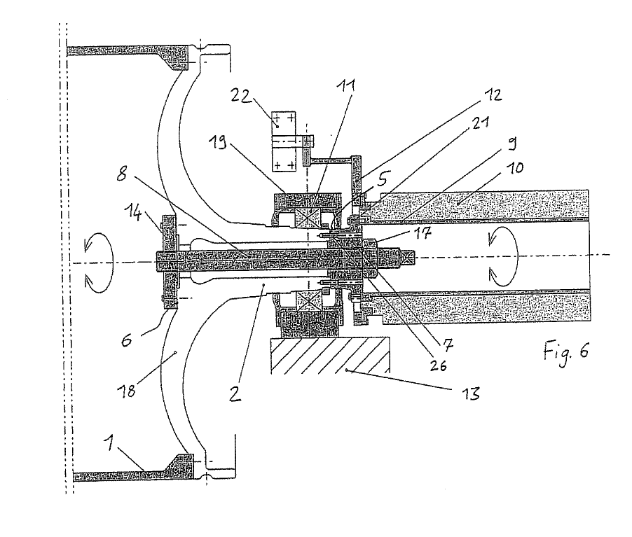

Shown in FIGS. 5 and 6 are more embodiments of the invention, wherein the embodiment according to FIG. 5 corresponds largely to that in FIG. 2. The embodiments according to FIGS. 5 and 6 differ however in that there is pinning between the drive flange 7 and the drive journal 2 by way of the pins shown over the circumference of the drive journal 2 and the pins 26 arranged in the end face of said drive journal. The same pins 26 project into corresponding bores in the end face of the drive flange 7, which lies opposite the axially outer end face 5 of the drive journal 2. To make it easier to insert the pins 26, said bores for the pins 26 can be constructed in the drive flange 7 as axial through-bores for example.

The pins 26 produce a form-locked connection between the drive flange 7 and the drive journal 2. For example, the pins can be in an interference fit with the drive journal 2 and the drive flange 7. The pins can be cylindrical pins for example.

According to the version shown in FIG. 6, the drive flange 7 and the tensioner 8 are not constructed in one piece; instead the tensioner 8 is enclosed by the drive flange 7 and braces itself in the axial direction against the drive flange 7 such that, when tensioned in the axial direction, the tensioner 8 presses the drive flange 7 against the outer end face 5 of the drive journal 2.

This can be effected in that, for example, the tensioner 8 has on its axially outer end an extension which presses against the drive flange 7. As FIGS. 2 to 4 show, provision can then be made accordingly on the axially inner end of the tensioner 8 for a tensioning device 17, for example in the form of a nut, to tension the tensioner 8.

However, on the version shown in FIG. 6 the tensioning device 17 is arranged on the axially outer end of the tensioner 8, as the result of which it can be reached from outside the roller or from outside the space enclosed by the roller casing 1. On the version shown, the tensioner 8 has in the region of its axially outer end a male thread onto which the tensioning device 17, again in the form of a hexagonal nut, is screwed with its female thread such that, when screwed on, the tensioning device 17 braces itself axially against the drive flange 7 and tensions the tensioner 8.

On the axially inner end of the tensioner 8 provision can be made for another tensioning device or retaining device, again in the form of a nut for example. On the version shown, however, the tensioner 8 is screwed into the pressure plate 14 in order to enable the tensioner 8 to be tensioned. Alternatively it would also be possible to construct the tensioner 8 and the pressure plate 14 in a single piece or, for example, to provide on the axially inner end of the tensioner 8 a projection with which the tensioner 8 braces itself against the pressure plate 14 in the axial direction.

As on the other embodiments shown, the pressure plate 14 is bolted in turn axially to the inner side of the drive journal 2 or to the cylinder cap 18.

On the version according to FIG. 6 the drive flange 7 is likewise pinned to the drive journal 2 (see the pins 26 arranged according to FIG. 5) in order to produce a form-locked connection between the drive journal 2 and the drive flange 7.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A drive end of a roller for at least one of producing and treating a material web, said drive end comprising:
a hollow-cylinder-shaped roller casing;
a drive unit;
a drive journal which is connected to said roller casing in order to drive said roller casing, said drive journal including an outer end face and an inner end face, said drive journal one of standing in a driven connection to said drive unit and being configured for being switched into said driven connection, said drive journal having an axial bore in a direction of an axis of rotation of the roller, said axial bore extending from said outer end face of said drive journal to said inner end face of said drive journal inside said roller casing; and
a drive flange on said outer end face of said drive journal, said drive flange configured for transmitting a drive torque onto said drive journal, said drive flange one of including a tensioner and being connected to said tensioner, said tensioner extending through said axial bore of said drive journal and being tensioned against said inner end face such that said tensioner one of tensions said drive flange against said outer end face and tensions said drive flange at least one of friction-locked and form-locked in a region of said outer end face of said drive journal.

2. The roller drive end according to claim 1, further including a bearing, wherein said drive journal is mounted in said bearing and carries said roller casing.

3. The roller drive end according to claim 2, wherein said bearing is a rolling bearing.

4. The roller drive end according to claim 2, wherein said drive unit includes a rotor, said drive flange connected to said rotor of said drive unit.

5. The roller drive end according to claim 4, wherein said drive flange is connected to said rotor of said drive unit using a bolted flange joint.

6. The roller drive end according to claim 4, wherein said drive flange is integral with said rotor of said drive unit.

7. The roller drive end according to claim 4, wherein said drive unit includes a stator which encloses said rotor in a circumferential direction from an outside, said stator being braced one of by using an anti-torsion torque arm against said bearing and by using a support carrying said bearing, a plurality of bracing forces being dissipated respectively into one of said bearing and said support.

8. The roller drive end according to claim 7, wherein said plurality of bracing forces one of in a plane of an axial center of said bearing and offset therefrom are dissipated respectively into one of said bearing and said support.

9. The roller drive end according to claim 2, wherein said drive flange has in a region axially outside said outer end face of said drive journal an outer diameter which is one of equal to and smaller than an outer diameter of said drive journal in a region of an axially outer end of said drive journal on which said drive journal is mounted in said bearing.

10. The roller drive end according to claim 2, wherein said bearing is a toroidal roller bearing.

11. The roller drive end according to claim 1, wherein said tensioner is tensioned one of by using a pressure plate against said inner end face of said drive journal and by using a cylinder cap connected to said drive journal.

12. The roller drive end according to claim 11, further comprising a tensioning device, wherein said tensioner includes an axial end, said pressure plate including a bore through which said tensioner is passed with said axial end, said axial end of said tensioner being equipped with a male thread which carries said tensioning device with a corresponding female thread, said tensioning device bracing itself against said pressure plate and being configured for tensioning said tensioner.

13. The roller drive end according to claim 12, wherein said tensioning device is a nut.

14. The roller drive end according to claim 1, wherein said drive flange is at least one of wedged against said drive journal and pinned to said journal.

15. The roller drive end according to claim 1, wherein said drive journal includes an outer casing surface, said drive flange being tensioned in a friction-locked connection against a hole cavity of said axial bore, against said outer end face of said drive journal, and from an outside against said outer casing surface of said drive journal.

16. The roller drive end according to claim 1, wherein said drive flange has no axial threaded connection to said outer end face of said drive journal and has no axial threaded connection to said drive journal except for a tensioning threaded connection of said tensioner.

17. The roller drive end according to claim 1, wherein said drive flange is a single piece with said tensioner and a tensioning of said drive flange on said drive journal is effected solely by using one of two and three components.

18. A method for mounting a drive end of a roller for at least one of producing and treating a material web, said method comprising the steps of:
providing the drive end which includes:
a hollow-cylinder-shaped roller casing;
a drive unit;
a drive journal which is connected to said roller casing in order to drive said roller casing, said drive journal including an outer end face and an inner end face, said drive journal one of standing in a driven connection to said drive unit and being configured for being switched into said driven connection, said drive journal having an axial bore in a direction of an axis of rotation of the roller, said axial bore extending from said outer end face of said drive journal to said inner end face of said drive journal inside said roller casing;
a drive flange on said outer end face of said drive journal, said drive flange configured for transmitting a drive torque onto said drive journal, said drive flange one of including a tensioner and being connected to said tensioner, said tensioner extending through said axial bore of said drive journal and being tensioned against said inner end face such that said tensioner one of tensions said drive flange against said outer end face and tensions said drive flange at least one of friction-locked and form-locked in a region of said outer end face of said drive journal, the roller being a drying cylinder of a paper machine; and
one of a steam head and a siphon of a steam pipeline system for directing steam into said drying cylinder being arranged in said axial bore of said drive journal; and
removing one of said steam head and said siphon; and
arranging said tensioner in its place.

19. A method for converting a non-driven journal of a roller for at least one of producing and treating a material web into a drive journal on a drive end, said method comprising the steps of:
inserting a tensioner into an axial bore at least one of:
of the journal, said axial bore being an existing said axial bore of the journal;
after one of newly adding said axial bore to the journal and adapting an existing said axial bore;
after replacing the journal with the drive journal including said axial bore; and
after one of arranging an additional drive journal on the journal and connecting said additional drive journal to the journal,
wherein the drive end includes:
a hollow-cylinder-shaped roller casing;
a drive unit;
the drive journal which is connected to said roller casing in order to drive said roller casing, the drive journal including an outer end face and an inner end face, the drive journal one of standing in a driven connection to said drive unit and being configured for being switched into said driven connection, the drive journal including said axial bore in a direction of an axis of rotation of the roller, said axial bore extending from said outer end face of the drive journal to said inner end face of the drive journal inside said roller casing; and
a drive flange on said outer end face of the drive journal, said drive flange configured for transmitting a drive torque onto the drive journal, said drive flange one of including said tensioner and being connected to said tensioner, said tensioner extending through said axial bore of the drive journal and being tensioned against said inner end face such that said tensioner one of tensions said drive flange against said outer end face and tensions said drive flange at least one of friction-locked and form-locked in a region of said outer end face of the drive journal.
